(19) United States
(12) Patent Application Publication
(10) Pub. No.: US 2010/0122810 A1
(43) Pub. Date: May 20, 2010

(54) WELL SCREENS AND METHOD OF MAKING WELL SCREENS

(76) Inventor: MICHAEL D. LANGLAIS, Hafrsfjord (NO)

Correspondence Address: SCHLUMBERGER RESERVOIR COMPLETIONS, 14910 AIRLINE ROAD, ROSHARON, TX, 77583, US

(21) Appl. No.: 12/274,002

(22) Filed: Nov. 19, 2008

(51) Int. Cl. E21B 43/08; B23P 11/00

(52) U.S. Cl. 166/230; 29/428

(57) ABSTRACT

Screens and methods of making screens for use in a well for producing fluids from an underground reservoir are provided. In one example, the screen includes first and second sections of mesh tube that radially encircle a base pipe and that filter a flow of reservoir fluids into the base pipe. The first section has an end portion and the second section has an end portion. The end portions are connected together by a lap joint.

### SUMMARY

In one example, a screen is provided for use in wells for producing fluids from an underground reservoir. The screen includes first and second sections of mesh tube that encircle a base pipe and that filter reservoir fluids flowing radially into the base pipe. The first section has an end portion that is connected to an end portion of the second section by a lap joint. The lap joint can be welded by a weld in such a way that either the first or second end portions provide a backing for the weld. In a further example, the end portions are swaged towards and away from the base pipe, respectively, and include chamfered edges.

In another example, an arrangement for producing fluids from an underground reservoir is provided. An axially elongated base pipe is radially encircled by an inner layer comprising a wire tube. The inner layer and base pipe define an axial flow path. A sand screen comprising a mesh tube encircles the inner layer and a shroud comprising a perforated tube encircles the sand screen. The sand screen has first and second sections that are connected by a lap joint. In a further example, the base pipe is impermeable except for a flow restriction located at a downstream end portion of the axial flow path. The flow restriction has a fixed flow cross section sized to receive reservoir fluids and to permit pressure reduction to thereby control reservoir fluid flow by fluid collision between reservoir fluid that has passed through the flow restriction and fluid downstream of the flow restriction.

In another example, a method of making a screen for use in an underground reservoir is provided. First and second sections of sand screen comprising mesh tubes are provided and a portion of the first section is overlapped onto a portion of the second section. The edges of the overlapped portions are welded so that the second section of the sand screen provides a backing during the welding step. In yet another example, the ends of the first and second sections are chamfered and swaged towards and away from the base pipe, respectively.

### BRIEF DESCRIPTION OF THE DRAWINGS

The best mode of carrying out the invention is described herein with reference to the following drawing figures.

FIG. 1 is a sectional view of a prior art inflow control device for controlling reservoir fluid flow into a well.

FIG. 2 is a view of Section 2-2 taken in FIG. 1.

FIG. 3 is a sectional view of a prior art arrangement for joining two mesh screen sections.

FIG. 4 is a view of Section 4-4 taken in FIG. 3.

FIG. 5 is a sectional view of an arrangement for joining two screen sections end to end.

FIG. 6 is a view of Section 6-6 taken in FIG. 5.

FIG. 7 is a sectional view of one example of a screen for incorporation into an inflow control device in accordance with the concepts described in the present application.

FIG. 8 is a view of Section 8-8 taken in FIG. 7.

FIG. 9 is a view of another example of the screen depicted in FIG. 7.

### DETAILED DESCRIPTION OF THE DRAWINGS

In the following description, certain terms have been used for brevity, clearness, and understanding. No unnecessary limitations are to be implied therefrom beyond the requirement of the prior art because such terms are used for descriptive purposes only and are intended to be broadly construed. The different arrangements and method steps described herein may be used alone or in combination with other arrangements, systems, and method steps. For example, the examples described herein are depicted in the context of inflow control devices. However, the examples are applicable for use with other types of well production equipment. It is to be expected that various equivalents, alternatives and modifications are possible within the scope of the appended claims.

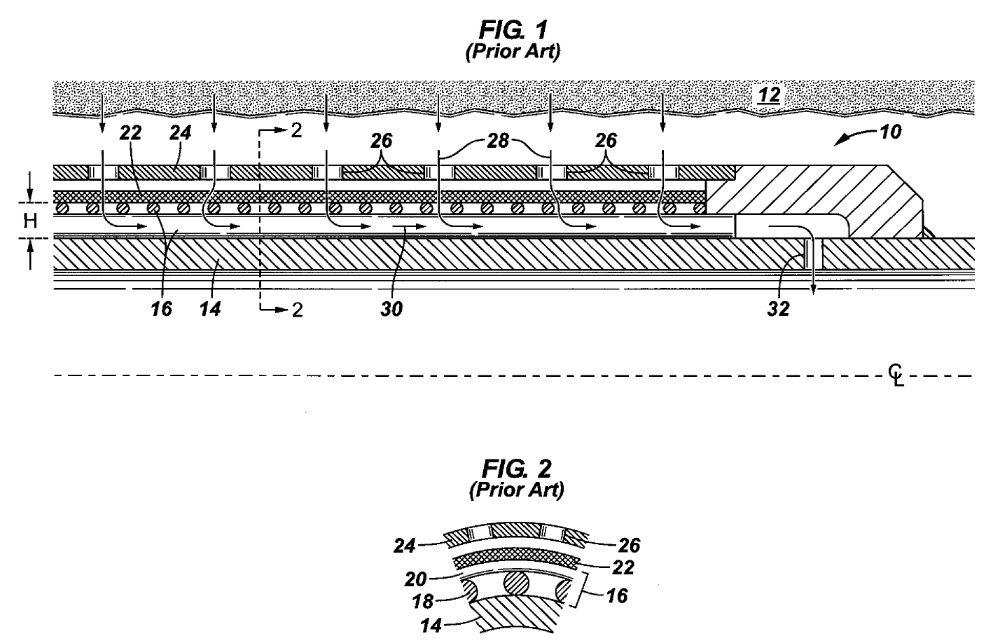

FIG. 1 depicts a conventional inflow control device 10 for use in a production well. The device 10 is specially designed to minimize fluctuating production rates and uneven drainage of fluids from a surrounding reservoir 12, as described in U.S. Pat. No. 7,419,002, the disclosure of which is incorporated herein by reference. The device 10 includes an axially elongated substantially non-perforated production tube or base pipe 14. An inner layer or wire tube 16 encircles the exterior of the base pipe 14. As shown in FIG. 2, the wire tube 16 includes a series of spaced apart axially extending wires 18 and a series of spaced apart laterally extending wires 20 that extend transversely to the wires 18. A sand screen or mesh tube 22 encircles the outside of wire tube 16 and a shroud 24 containing a series of perforations 26 overlaps the mesh tube 22. A series of radial flow paths 28 allow reservoir fluids to flow radially towards the base pipe 14 through the perforations 26, the mesh tube 22, and the wire tube 16.

An axial flow path 30 extends along the exterior of the non-perforated base pipe 14 and has a height H defined by the spacing between the exterior face of the based pipe 14 and the interior face of the wire tube 16. One or more inlets 32 are provided in the base pipe 14 at the upstream end of the axial flow path 30. As explained in the aforementioned U.S. Pat. No. 7,419,002, at least one flow restriction such as the inlet 32 itself or an insert (not shown) is provided in the flow channel. The insert can include a nozzle or an orifice in the shape of a slit or a hole or any other flow restriction. The flow restriction (e.g., 32) has a fixed flow cross-section sized to receive reservoir fluids and to permit pressure reduction and thereby control of reservoir fluid flow by fluid collision between reservoir fluid that has passed through the flow restriction and downstream fluid.

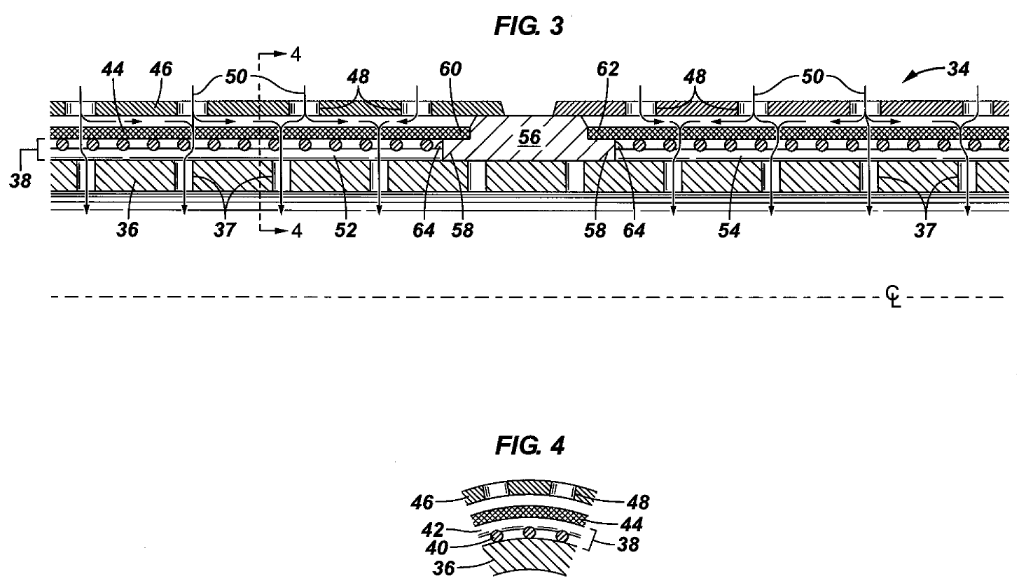

Inflow control devices 10 are often designed to extend axially more than 32 feet in length to achieve the desired reservoir contact and/or flow control characteristics. However sand screens such as the mesh tube 22 shown in FIG. 1 are typically manufactured in sections that are 16 feet or less in axial length. Therefore, the applicant has found that it is necessary to join two or more screen sections in series (i.e., end-to-end) to create an inflow control device 10 that is longer than 16 feet. While pursuing this objective, the applicant was unsuccessful in its attempts to effectively incorporate several known arrangements for joining two or more sections of sand screens in series (i.e., “end-to-end”) into the inflow control device 10. Some of these arrangements are described herein below with reference to FIGS. 3-6.

FIG. 3 depicts one arrangement 34 considered by the applicant for joining two or more sand screen sections in an inflow control device 10. The arrangement includes a base pipe 36 having a high-density pattern of perforations 37. An inner layer or wire tube 38 is wrapped around the exterior of the base pipe 36. The wire tube 38 includes a series of spaced apart axially extending wires 40 and spaced apart laterally extending wires 42 that extend transversely to the wires 40, as shown in FIG. 4. A sand screen or mesh tube 44 is wrapped around the outside of wire tube 38 and a shroud 46 containing a series of perforations 48 overlaps the mesh tube 42. A series of radial flow paths 50 are defined for reservoir fluids to flow radially into the base pipe 36 through the perforations 48, the mesh tube 44, the wire tube 38, and perforations 37. The mesh tube 44 includes a first section 52 and a second section 54 that are joined by a junction ring 56. The junction ring 56 contains an outwardly extending lip or flange portions 58. The flange portions 58 underlie an end portion 60 of the first section 52 of the mesh tube 44 and an end portion 62 of the second section 54 of mesh tube 44. The junction ring 56 thus provides a backing for the filter mesh 26 and a point at which the filter mesh 26 can be welded together at defined welding points 64.

The arrangement shown in FIGS. 3 and 4 may not be effectively and efficiently incorporated into the inflow control device 10 shown in FIG. 1. The junction ring 56 extends towards or up to the exterior surface of the base pipe 36 and therefore substantially prevents or blocks fluid from flowing axially along (i.e., adjacent to) the exterior surface of the base pipe 36. This “blocking effect” presents a significant problem if the junction ring 56 is incorporated into the inflow control device 10 shown in FIG. 1, which is designed to promote both radial flow along flow paths 28 and axial flow along flow path 30. In other words, in the inflow control device 10, it is necessary to minimize the amount of restriction along the length of the axial flow path 30 to prevent fluid pressure losses and maintain a constant flow. The presence of the junction ring 56 protruding into or blocking the axial flow path 30 disrupts flow of fluid through the path 30 and thus interferes with the operation of the inflow control device 10.

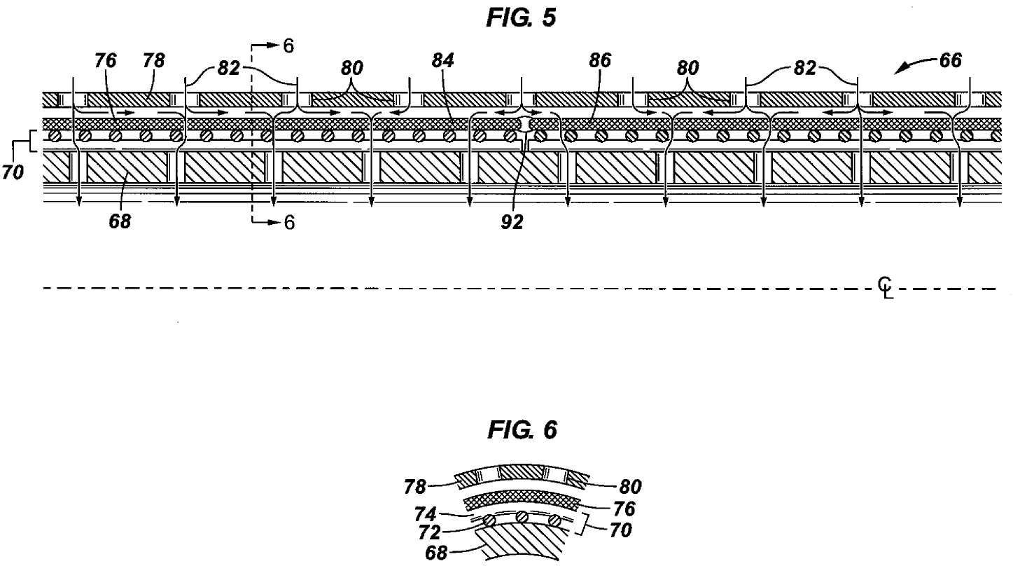

FIG. 5 depicts another arrangement 66 considered by the applicant for joining two or more sand screen sections in an inflow control device 10. The arrangement includes a perforated base pipe 68. An inner layer or wire tube 70 is wrapped around and encircles the exterior of the base pipe 68. The wire tube 70 includes a series of spaced apart axially extending wires 72 and spaced apart laterally extending wires 74 that extend transversely to the wires 72, as shown in FIG. 6. A sand screen or mesh tube 76 is wrapped around the outside of the wire tube 70 and a shroud 78 containing a series of perforations 80 overlaps the mesh tube 76. A series of radial flow paths 82 are defined for reservoir fluids to flow radially towards the base pipe 68 through the perforations 80, the mesh tube 76, and the wire tube 70. The mesh tube 76 includes a first section 84 and a second section 86. An axial end 88 of the first section 84 is welded directly to an axial end 90 of the second section 86 by a butt weld 92.

The arrangement shown in FIGS. 5 and 6 may not be effectively and efficiently incorporated into the inflow control device 10 because the quality of the butt weld 92 shown in FIG. 5 is very difficult to control or verify. The quantity of weld penetration can vary widely from partial to full penetration. Full penetration of the weld results in the best joint achieving the maximum joint strength. However in the arrangement 66, there is no efficient quality control measure during production that could ensure that full weld penetration was achieved.

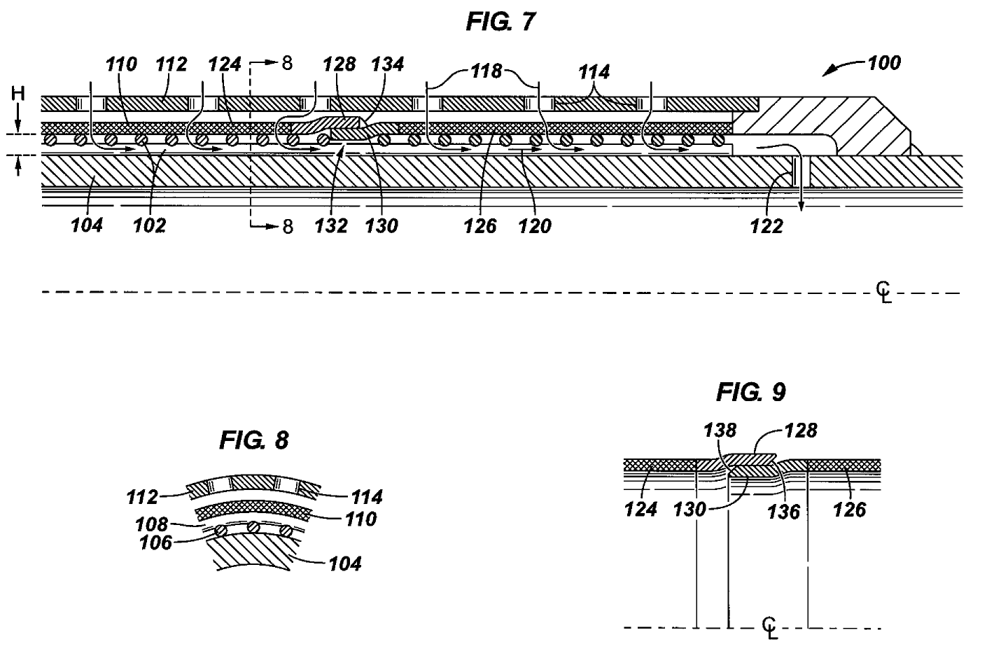

FIG. 7 depicts an arrangement 100 for producing fluids from an underground reservoir that surprisingly overcomes many of the disadvantages of the attempts shown in FIGS. 2-6.

An inner layer or wire tube 102 is wrapped around the exterior of an axially elongated substantially non-perforated production tube or base pipe 104. The wire tube 102 includes a series of spaced apart axially extending wires 106 and a series of spaced apart laterally extending wires 108 that extend transversely to the wires 106, as shown in FIG. 8. A sand screen or mesh tube 110 is wrapped around the outside of wire tube 102 and a shroud 112 containing a series of perforations 114 overlaps the mesh tube 116. A series of radial flow paths 118 are defined for reservoir fluids to flow radially towards the base pipe 104 through the perforations 114, the mesh tube 116, and the wire tube 102.

An axial flow path 120 extends along the exterior of the non-perforated base pipe 104 and has a height H defined by the spacing between the exterior of the based pipe 104 and the interior of the wire tube 102. One or more inlets 122 are provided in the base pipe 104 at the upstream end of the axial flow path 120. At least one flow restriction (e.g., 122) is provided in the flow path 120 and can include a nozzle or an orifice in the shape of a slit or a hole or any other flow restriction. The flow restriction (e.g., 122) has a fixed flow cross-section sized to receive reservoir fluids and to permit pressure reduction and thereby control of reservoir fluid flow by fluid collision between reservoir fluid that has passed through the flow restriction (e.g., 122) and downstream fluid.

The sand screen or mesh tube 110 includes first and second sections 124, 126 that filter reservoir fluids flowing radially into the base pipe 104 along flow paths 118. The first section 124 has a downstream end portion 128 and the second section 126 has an upstream end portion 130. The downstream end portion 128 and upstream end portion 130 are overlapped and connected by a lap joint 132. In the example shown, the lap joint 132 is formed by swaging the downstream end portion 128 out away from the base pipe 104 and swaging the upstream end portion 130 in towards the base pipe 104. Note that this is one preferred arrangement and could be modified accordingly. For example, the lap joint could be formed by having only one of the downstream and upstream end portions 128, 130 swaged in towards the base pipe 104 or out away from the base pipe 104. The lap joint 132 is welded by a weld 134 which can be for example a butt weld, fillet weld or like in such a manner that the downstream portion 124 forms a backing for the weld 134 which can be for example a butt weld, fillet weld or like. This ensures a quality weld and overcomes the disadvantages of the arrangement 66 shown in FIG. 5.

FIG. 9 depicts an additional example wherein each end portion 128, 130 comprises an edge 136, 138 that is chamfered to achieve a better fit between the end portions.

The arrangements and methods described with reference to FIGS. 7-9 surprisingly provide several functional advantages over the prior art. For example, the lap joint 132 facilitates a smaller radial clearance between the shroud 112 and the mesh tube 110, which greatly improves burst characteristics of the mesh tube 110. That is, the smaller the radial clearance between the shroud 112 and the mesh tube 110, the less likely the mesh tube 110 is to expand towards the shroud 112. This helps maintain the pore size in the mesh under burst conditions and thus does not compromise the filtering ability of the mesh tube 110. The lap joint 132 also facilitates a larger radial clearance H between the outside of the base pipe 104 and the inside surface of the wire tube 102. As discussed above, this is highly advantageous because it minimizes the amount of flow restriction on fluids flowing axially through the axial flow path 120.

The arrangements shown in FIGS. 7-9 allow for design of an inflow control device 10 that utilizes multiple mesh tube sections to achieve the desired screen to reservoir contact length. Although FIGS. 7-9 show two sections of sand screen joined together, it is recognized that additional sections can be connected in series to arrive at a substantially longer inflow control device 10.

What is claimed is:

1. A screen for use in a well for producing fluids from an underground reservoir, the screen comprising first and second sections of mesh tube that encircle a base pipe, the first section having an end portion and the second section having an end portion, wherein the respective end portions are connected together by a lap joint.

2. The screen of claim 1, wherein the lap joint is welded.

3. The screen of claim 2, wherein the lap joint is welded and wherein one of the end portions provides a backing for the weld.

4. The screen of claim 1, wherein one of the end portions is swaged in towards the base pipe.

5. The screen of claim 4 wherein the other of the end portions is swaged out away from the base pipe.

6. The screen of claim 1, wherein one of the end portions is swaged out away from the base pipe.

7. The screen of claim 1, wherein one of the end portions comprises an edge that is chamfered.

8. The screen of claim 7, wherein the other of the end portions comprises an edge that is chamfered.

9. An arrangement for producing fluids from an underground reservoir, the arrangement comprising:
an axially elongated base pipe;
an inner layer comprising a wire tube that radially encircles the base pipe, wherein an axial flow path is defined between the base pipe and the inner layer;
a sand screen comprising a mesh tube that is wrapped around the inner layer; and
a shroud comprising a perforated tube that is wrapped around the sand screen;
wherein the sand screen has first and second sections, the first section connected to the second section by a lap joint.

10. The arrangement of claim 9, wherein the axial flow path flows from the underground reservoir to the inside of the base pipe.

11. The arrangement of claim 10, wherein the inner layer, sand screen, and shroud together define a radial flow path for reservoir fluids to flow into the axial flow path.

12. The arrangement of claim 11, wherein the base pipe is impermeable except for a flow restriction located at an upstream end portion of the axial flow path, the flow restriction having a flow cross-section sized to receive reservoir fluids and to permit pressure reduction and thereby control of reservoir fluid flow by fluid collision between reservoir fluid that has passed through the flow restriction and fluid downstream of said flow restriction.

13. The arrangement of claim 12, wherein the flow restriction comprises one of a nozzle and an orifice.

14. A method of making a screen for use in a well for producing fluids from an underground reservoir, the method comprising the steps of:
providing a first section of sand screen comprising a mesh tube;
providing a second section of sand screen comprising a mesh tube;
swaging an end of the first section;
overlapping the swaged end of the first section onto an end of the second section; and
welding the swaged end of the first section to the second section, whereby the second section provides a backing during the welding step.

15. The method of claim 14, further comprising the step of chamfering an edge of the swaged end of the first section.

16. The method of claim 14, further comprising the step of chamfering an edge of the end of the second section.

17. The method of claim 14, further comprising the step of swaging the end of the second section in a direction opposite of the swaged end of the first section.
